(19) United States
(12) Patent Application Publication
(10) Pub. No.: US 2016/0036104 A1
(43) Pub. Date: Feb. 4, 2016

(54) BATTERY CELL HEAT EXCHANGER WITH GRADED HEAT TRANSFER SURFACE

(71) Applicant: Dana Canada Corporation, Oakville (CA)

(72) Inventors: Benjamin A. Kenney, Toronto (CA); Nik Vucenic, Hamilton (CA); Michael Bardeleben, Oakville (CA)

(21) Appl. No.: 14/813,691

(22) Filed: Jul. 30, 2015

Related U.S. Application Data
(60) Provisional application No. 62/031,553, filed on Jul. 31, 2014.

(51) Int. Cl. H01M 10/6556

(52) U.S. Cl. CPC H01M 10/6556

(57) ABSTRACT

A battery cell heat exchanger formed by a pair of mating plates that together form an internal tubular flow passage. The tubular flow passage is generally in the form of a serpentine flow passage extending between an inlet end and an outlet end and having generally parallel flow passage portions interconnected by generally U-shaped flow passage portions. The flow passage provides a graded heat transfer surface within each generally parallel flow passage portion and/or a variable channel width associated with each flow passage portion to provide improved temperature uniformity across the surface of the heat exchanger. The graded heat transfer surface may be in the form of progressively increasing the surface area associated with the individual flow passage portions with heat transfer enhancement features or surfaces arranged within the flow passage portions. The channel width and/or height may also be varied so as to progressively decrease for each flow passage portion.

### CROSS-REFERENCE TO RELATED APPLICATION

This application claims priority to and the benefit of U.S. Provisional Patent Application No. 62/031,553, filed Jul. 31, 2014 under the title BATTERY CELL HEAT EXCHANGER WITH GRADED HEAT TRANSFER SURFACE. The content of the above patent application is hereby expressly incorporated by reference into the detailed description of the present application.

### TECHNICAL FIELD

This disclosure relates to battery cell heat exchangers or cold plate heat exchangers used to dissipate heat in battery units.

### BACKGROUND

Rechargeable batteries such as batteries made up of many lithium-ion cells can be used in many applications, including for example, electric propulsion vehicle (“EV”) and hybrid electric vehicle (“HEV”) applications. These applications often require advanced battery systems that have high energy storage capacity and can generate large amounts of heat that needs to be dissipated. Battery thermal management of these types of systems generally requires that the maximum temperature of the individual cells be below a predetermined, specified temperature. More specifically, the battery cells must display battery cell temperature uniformity such that the difference between the maximum temperature (Tₘₐₓ) within the cell and the minimum temperature (Tₘᵢₙ) within the cell, e.g. Tₘₐₓ-Tₘᵢₙ, be less than a specified temperature. Additionally, any fluid flowing through the heat exchangers used for cooling the batteries must exhibit low pressure drop through the heat exchanger to ensure proper performance of the cooling device.

Cold plate heat exchangers are heat exchangers upon which a stack of adjacent battery cells or battery cell containers housing one or more battery cells are arranged for cooling and/or regulating the temperature of a battery unit. The individual battery cells or battery cell containers are arranged in face-to-face contact with each other to form the stack, the stack of battery cells or battery cell containers being arranged on top of a cold plate heat exchanger such that an end face or end surface of each battery cell or battery cell container is in surface-to-surface contact with a surface of the heat exchanger. Heat exchangers for cooling and/or regulating the temperature of a battery unit can also be arranged between the individual battery cells or battery cell containers forming the stack, the individual heat exchangers being interconnected by common inlet and outlet manifolds. Heat exchangers that are arranged or “sandwiched” between the adjacent battery cells or battery cell containers in the stack may sometimes be referred to as inter-cell elements (e.g. “ICE” plate heat exchangers) or cooling fins.

For both cold plate heat exchangers and inter-cell elements or ICE plate heat exchangers, temperature uniformity across the surface of the heat exchanger is an important consideration in the thermal management of the overall battery unit as the temperature uniformity across the surface of the heat exchanger relates to ensuring that there is a minimum temperature differential between the individual battery cells in the battery unit. For cold plate heat exchangers in particular, these requirements translate into ensuring that the maximum temperature of the surface of the cold plate be as low as possible with the temperature across the plate being as uniform as possible to ensure consistent cooling across the entire surface of the plate.

Accordingly, there is a need for improved battery cell heat exchangers offering improved temperature uniformity across the heat transfer surface that comes into contact with the battery units for ensuring adequate dissipation of the heat produced by these battery systems/units.

### SUMMARY OF THE PRESENT DISCLOSURE

In accordance with an example embodiment of the present disclosure there is provided a battery cell heat exchanger comprising a pair of mating heat exchange plates, the pair of mating heat exchange plates together forming an internal multi-pass tubular flow passage therebetween; the multi-pass tubular flow passage having an inlet end and an outlet end and a plurality of generally parallel flow passage portions interconnected by generally U-shaped flow passage portions, the generally parallel flow passage portions and generally U-shaped portions together interconnecting said inlet end and said outlet end; a fluid inlet in fluid communication with said inlet end of said flow passage for delivering a fluid to said heat exchanger; a fluid outlet in fluid communication with said outlet end of said flow passage for discharging said fluid from said heat exchanger; wherein each generally parallel flow passage portion defines a flow resistance and heat transfer performance characteristic, the flow resistance and heat transfer performance characteristic of each of said generally parallel flow passage portions increasing between the inlet end and the outlet end.

In accordance with another exemplary embodiment of the present disclosure there is provided a battery unit comprising a plurality of battery cell containers each housing one or more individual battery cells wherein the battery cell containers are arranged in adjacent, face-to-face contact with each other; a battery cell heat exchanger arranged underneath said plurality of battery cell containers such that an end face of each battery cell container is in surface-to-surface contact with said heat exchanger; wherein each battery cell heat exchanger comprises a pair of mating heat exchange plates, the pair of mating heat exchange plates together forming a multi-pass tubular flow passage therebetween; the multi-pass tubular flow passage having an inlet end and an outlet end and a plurality of generally parallel flow passage portions interconnected by generally U-shaped flow passage portions, the generally parallel flow passage portions and generally U-shaped portions together interconnecting said inlet end and said outlet end; a fluid inlet in fluid communication with said inlet end of said flow passage for delivering a fluid to said heat exchanger; a fluid outlet in fluid communication with said outlet end of said flow passage for discharging said fluid from said heat exchanger; wherein each generally parallel flow passage portion defines a flow resistance and heat transfer performance characteristic, the flow resistance and heat transfer performance characteristic of each generally parallel flow passage portion increasing between the inlet end and the outlet end.

### BRIEF DESCRIPTION OF THE DRAWINGS

Reference will now be made, by way of example, to the accompanying drawings which show example embodiments of the present application, and in which:

FIG. 1 is a perspective view of a battery unit incorporating a battery cell heat exchanger according an exemplary embodiment of the present disclosure;

FIG. 1A is a schematic longitudinal cross-sectional view through a pass of the multi-pass flow passage of a battery cell heat exchanger according to the present disclosure;

FIG. 2 is a perspective, exploded view of a battery cell heat exchanger according to the present disclosure;

FIG. 3 is a top view of the bottom plate of the battery cell heat exchanger of FIG. 2;

FIG. 3A is a top view of an alternate embodiment of the bottom plate of the battery cell heat exchanger of FIG. 2;

FIG. 3B is a top view of an alternate embodiment of the bottom plate of the battery cell heat exchanger of FIG. 2;

FIG. 4 is a perspective view of a battery cell heat exchanger incorporating the bottom plate of FIG. 3B;

FIG. 4A is a detail view of the encircled area A found in FIG. 4;

FIG. 5 is a table of results illustrating the performance results of various heat exchanger plates including the heat exchanger plates with graded heat transfer surface according to an embodiment of the present disclosure;

FIG. 6 is a table of results illustrating the flow rates required for various heat exchanger plates including the heat exchanger plates with graded heat transfer surface according to an embodiment of the present disclosure;

FIG. 7 is a top view of a bottom plate for a battery cell heat exchanger according to another example embodiment of the present disclosure;

FIG. 8 is perspective, exploded view of a heat exchanger according to another example embodiment of the present disclosure;

FIG. 8A is a top view of the bottom plate of the heat exchanger of FIG. 8;

FIG. 9 is a table of results illustrating the performance results of various heat exchanger plates including the heat exchanger plates with graded heat transfer surface according to an embodiment of the present disclosure; and

FIG. 10 is a perspective, exploded view of a battery cell heat exchanger according to another example embodiment of the present disclosure;

FIG. 10A is a top view of the bottom plate of the heat exchanger of FIG. 10;

FIG. 10B is a detail view of the encircled area B illustrated in FIG. 10; and

FIG. 11 is a perspective view of a battery unit incorporating battery cell heat exchangers according an exemplary embodiment of the present disclosure wherein the heat exchangers arranged in between adjacent battery cells or battery cell containers forming the battery unit.

Similar reference numerals may have been used in different figures to denote similar components.

### DESCRIPTION OF EXAMPLE EMBODIMENTS

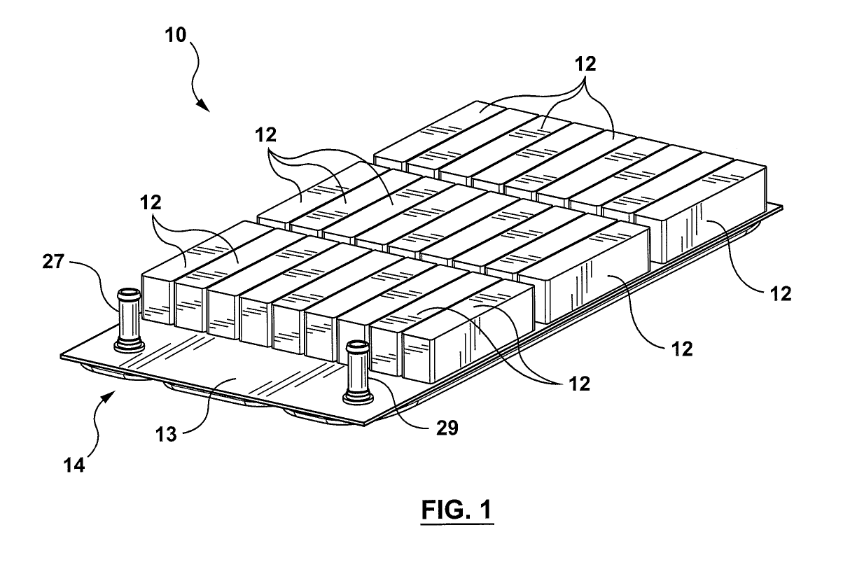

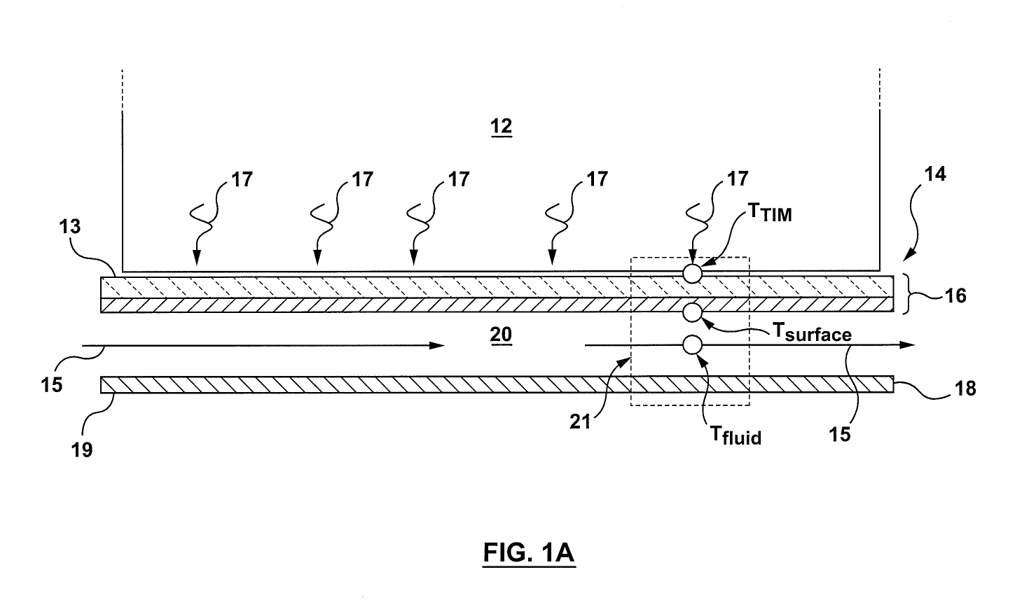

Referring now to FIG. 1 there is shown an illustrative example of a rechargeable battery unit according to an example embodiment of the present disclosure. The battery unit 10 is made up of a series of individual battery cells or battery cell cases housing one or more individual battery cells 12. A battery cell cooler or battery cell heat exchanger 14 in the form of a cold plate is arranged underneath the stack of battery cells or battery cell cases 12. Accordingly, the plurality of battery cells or battery cell cases 12 are arranged in face-to-face contact with each other to form a stack, the stack of battery cells or battery cell containers then being arranged on top of a cold plate heat exchanger such that an end face or end surface of each battery cell or battery cell container 12 is in surface-to-surface contact with a primary heat transfer surface 13 of the heat exchanger 14. Each battery cell heat exchanger 14 is formed by a pair of mating, plates 16, 18 that together form an internal tubular flow passage 20. The flow passage 20 has an inlet end 22 and an outlet end 24. An inlet opening 26 is formed in the first or upper plate 16 of the heat exchanger 14 at the inlet end 22 of the flow passage 20 and is in fluid communication with an inlet fixture 27 for allowing a cooling fluid to enter into the flow passage 20. An outlet opening 28 is formed in the first or upper plate 16 of the heat exchanger at the outlet end 24 of the flow passage 20 in fluid communication with an outlet fixture 29 for discharging the cooling fluid from the flow passage 20. As shown, the inlet and outlet fixtures 27, 29 are both arranged at one end of the heat exchanger 14, although different placements of the inlet and outlet fixtures are possible depending upon the particular application and required locations for the inlet and outlet fittings 27, 29.

According to an example embodiment of the present disclosure, the battery cell heat exchanger 14 is in the form of a multi-pass heat exchanger that defines the internal tubular flow passage 20, the internal tubular flow passage 20 being in the form of a serpentine flow passage extending between the inlet end 22 and the outlet end 24. Accordingly, the flow passage 20 includes a multiple serially connected generally parallel flow passage portions 32 that are each connected to a successive flow passage portion 32 by a respective substantially U-shaped flow passage portion 34. In operation, a heat exchange fluid such as a cooling fluid enters flow passage 20 through inlet opening 26, flows through the first generally parallel flow passage portion 32(1) and through the first U-shaped flow passage portion 34(1) into the second generally parallel flow passage portion 32(2). The heat exchanger fluid is then “switched-back” through the second U-shaped flow passage portion 34(2) before it continues through the third generally parallel flow passage portion 32(3) and so on until the fluid flows through the final generally parallel flow passage portion 32(4) before exiting the flow passage 20 through outlet opening 28. While the flow passage 20 has been shown as having four generally parallel flow passage portions 32(1)-32(4) and three U-shaped flow passage portions 34(1)-34(3), it will be understood that this is not intended to be limiting and that the actual number of parallel and U-shaped flow passage portions 32, 34 forming the flow passage 20 may vary depending on the specific application of the product in terms of the required overall size of the heat exchanger, the specific heat transfer and/or pressure drop requirements for a particular application, as well as the specific size of the battery cells 12 and the actual size of the heat exchanger plates 16, 18 forming the battery cell heat exchanger 14. In general, the battery cell heat exchanger 14 may have a minimum of three generally parallel flow passage portions up to about ten, for example. As the battery cell heat exchanger 14 is intended to be arranged so as to be in thermal contact with a side of a battery cell in order to provide cooling to or to allow heat to dissipate from the battery cell, it is important that the battery cell heat exchanger 14 provide a heat transfer surface that has a generally uniform temperature across its surface to ensure adequate cooling is provided across the entire side or surface of the adjacent battery cell 12 that is in surface-to-surface contact with the battery cell heat exchanger 14. In order to improve temperature uniformity across the surface of the battery cell heat exchangers 14, the flow passage 20 is configured to so that the flow resistance and heat transfer performance for each of the generally parallel flow passage portions 32(1)-32(4) progressively increases so as to provide a graded or variable overall flow passage 20 through the heat exchanger 14.

It is generally understood that the temperature across the surface (T_{surface}) of the heat exchanger plates 16, 18 is a function of the temperature of the fluid (T_{fluid}) in the flow passage 20 as well as the product of the heat transfer coefficient (h) and the projected area (A) of the plates 16, 18 and is generally represented by the following equation:

T_{surface}=T_{fluid}+Q/hA

where Q=mCₚ (Tₒᵤₜ-Tᵢₙ)
m=mass flow rate
Cₚ=specific heat at constant pressure
T_{fluid}=½ (Tᵢₙ+Tₒᵤₜ)
h=heat transfer coefficient of the surface
A=surface area
   and where both Q and T_{fluid} are generally considered to be constant.

Typically, it has been found that in order to meet the temperature uniformity requirement for these types of battery units 10 it is necessary to increase the flow rate of the heat exchanger fluid through the battery cell heat exchanger. However, increasing the flow rate has been known to increase pressure drop across known battery cell heat exchangers which can decrease the overall performance of the heat exchangers and, thus, decrease the overall performance of the battery unit 10. However, by providing a battery cell heat exchanger 14 with a graded or variable multi-pass flow passage 20 that provides progressively increasing flow resistance and heat transfer performance through each pass of the multi-pass flow passage 20 or across the overall length of the flow passage 20, it has been found that improved temperature uniformity across the surface of the heat exchanger plates 16, 18 may be achieved. More specifically, it has been found that improved temperature uniformity may be achieved by varying the surface area of the flow passage 20 between the inlet end 22 and the outlet 24 by providing a graded heat transfer surface through the flow passage 20 and/or varying the width of the flow passage 20 along the length thereof.

It is generally understood that as the heat exchange or cooling fluid enters the heat exchanger 14, as represented schematically in FIG. 1A by flow directional arrow 15, the surface temperature of the heat exchanger plates 16, 18 at the inlet is cold (e.g. low surface temperature). As heat (Q) dissipates from the battery cells 12, as represented schematically in FIG. 1A by heat dissipation arrows 17, and is transferred from the battery cells 12 to the heat exchange fluid flowing through the flow passage 20 through surface-to-surface contact with the outer surface 19 of the heat exchanger plates 16, 18, the temperature of the heat exchange fluid within the flow passage 20 increases which has an effect on the surface temperature of the plates 16, 18, the maximum surface temperature, T_{TIM}, of the heat exchanger plates 16, 18 generally being located on the outer surface 19 of the plates 16, 18 towards the outlet end 24 of the flow passage 20 as represented schematically in FIG. 1A by the discretized volume 21 shown in dotted lines. Accordingly, the surface temperature of the heat exchanger plates 16, 18 at the outlet end 24 of the heat exchanger 14 is considered to be “hot” (e.g. high surface temperature) as compared to the surface temperature found at the inlet end 22 of the heat exchanger 14. The difference in surface temperature between the inlet end and outlet end of the plates 16, 18 results in a large temperature gradient across the surface of the heat exchangers plates 16, 18, which tends to have an adverse effect on the temperature uniformity requirement for battery cell heat exchangers for these types of battery units 10. By increasing the surface temperature at the inlet end 22 of the heat exchanger 14, the overall temperature gradient across the surface of the plates 16, 18 can be reduced in order to meet the temperature uniformity requirements associated with these types of battery units and particular applications. Since the surface temperature of the plates 16, 18 is dictated by the equation Tsurface=Tfluid+Q/hA set out above, it has been found that the surface temperature can be changed by altering the surface area (A) of the heat transfer surface and/or the fluid velocity passing through the heat exchanger which influences the heat transfer coefficient (h). While this traditionally has been done by increasing the flow rate of the heat exchange fluid entering the heat exchanger, this has been known to also have an adverse effect on the overall performance of the heat exchanger due to an increase in pressure drop.

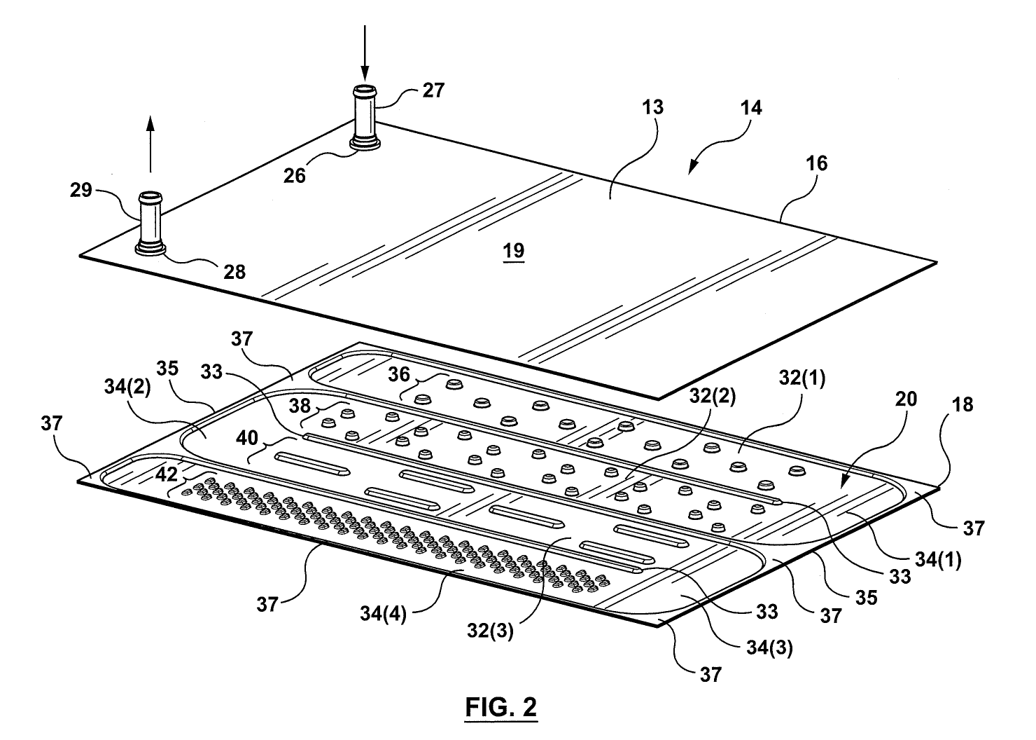

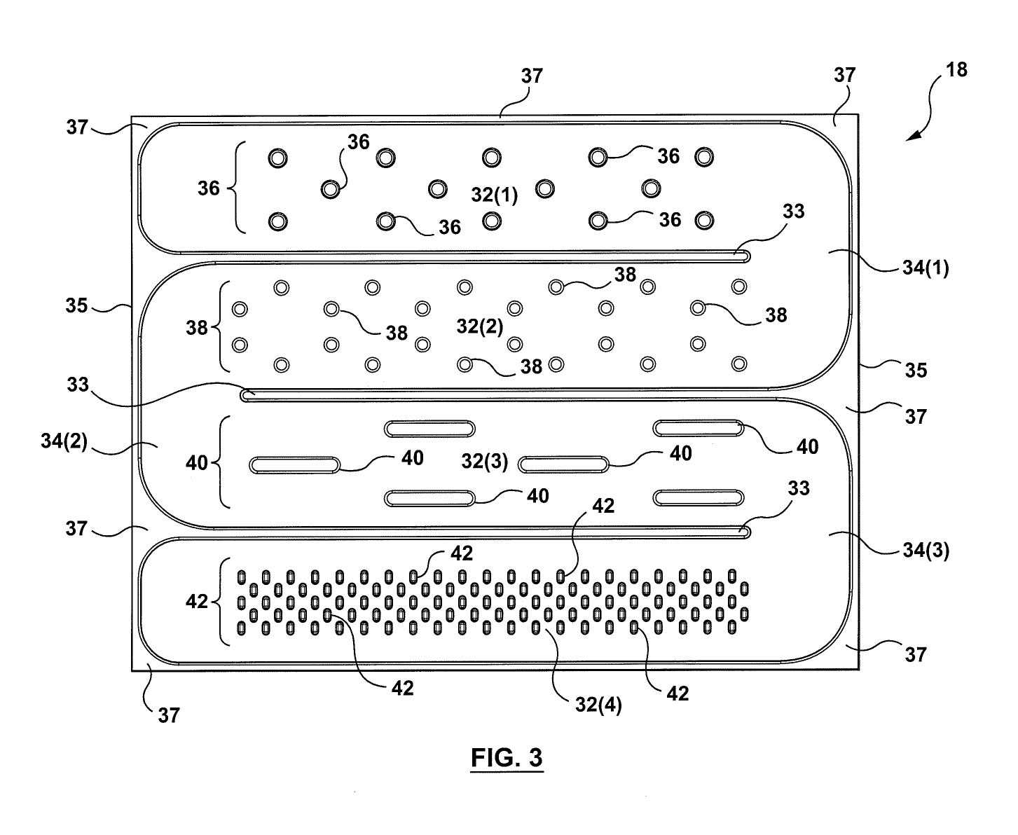

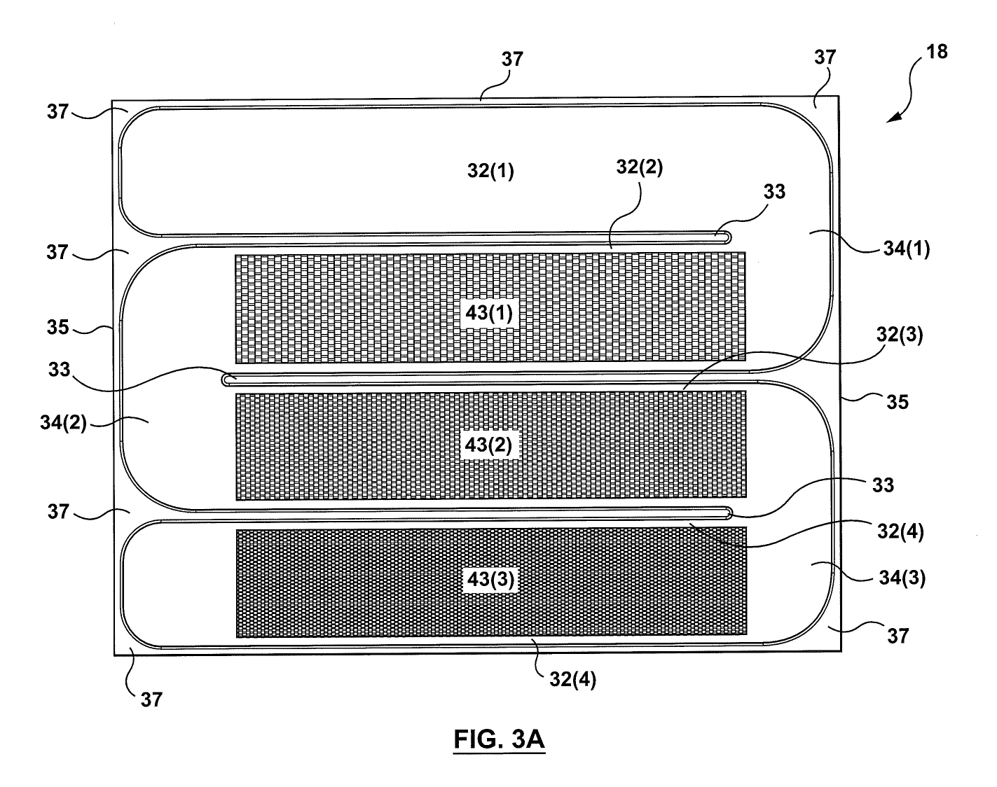

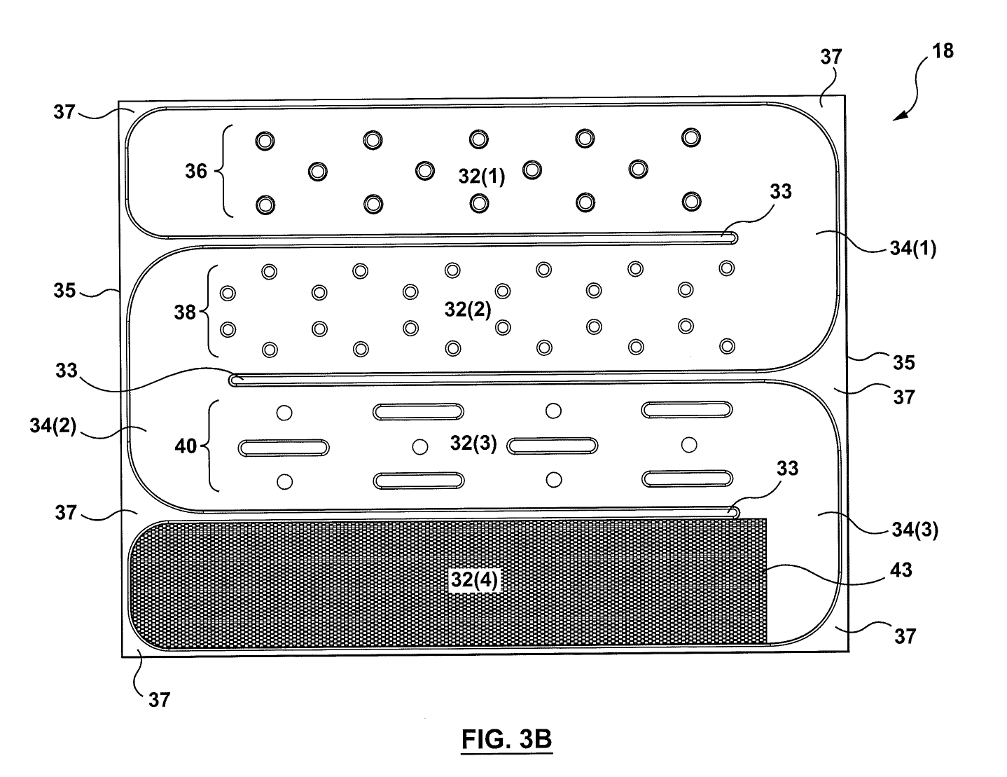

Referring now to FIG. 2 there is shown an exemplary embodiment of a battery cell heat exchanger 14 according to the present disclosure. The heat exchanger 14 is comprised of a pair of mating heat exchanger plates 16, 18. In the subject embodiment, the first or upper plate 16 is in the form of a generally planar plate having an outer surface 19 for contacting with the individual battery cells or battery cell cases 12 that are arranged on top of or stacked upon the outer surface 19 of the first or upper plate 16, the first or upper plate 16 of the heat exchanger 14 therefore defining the primary heat transfer surface 13. The second or bottom plate 18 of the heat exchanger 14 has a central, generally planar area in which the generally serpentine flow passage 20 is formed. In the subject embodiment, the generally parallel flow passage portions 32(1)-32(4) (or in general 32(n)) and the U-shaped flow passage portions 34(1)-34(3) (or in general 34(n−1)) are formed as a serpentine depression that extends outwardly away from the central generally planar area of the second plate 18. Accordingly, the generally parallel flow passage portions 32(n) are separated from each other by flow barriers 33 generally in the form of longitudinal ribs that extend from one of the corresponding end edges 35 of the second plate 18, with a peripheral flange portion 37 extending around the perimeter of the plate 18. When the first and second plates 16, 18 are arranged together in their mating relationship, the lower or inner surface of the first plate 16 seals against the upper surfaces of the flow barriers 33 and the peripheral flange 37 of the second plate 18 enclosing the flow passage 20 therebetween. In order to provide a progressively increasing surface area within the flow passage (e.g. a graded or varied heat transfer surface within the enclosed flow passage 20) in order to increase the surface temperature at the inlet end 22 of the heat exchanger 14 in order to improve overall temperature uniformity across the surface of the heat exchanger 14, the surface area of the flow passage 20 is modified through at least each of the generally parallel flow passage portions 32(1)-32(4) to create a low density surface area heat transfer surface near the inlet end 22 of the flow passage 20 and a high density surface area heat transfer surface at the outlet end 24 of the flow passage 20. As shown in FIGS. 2 and 3, the first generally parallel flow passage portion 32(1) is formed with low density surface enhancement features 36 across its surface area, such as low density or spaced-apart protrusions in the form of dimples, while the second parallel flow passage portion 32(2) is formed with higher density or more closely spaced surface enhancement features or protrusions 38 in the form of higher density or more closely spaced dimples across the surface area of the second flow passage portion 32(2) so as to provide an overall medium density surface area as compared to the first flow passage portion 32(1). The third parallel flow passage portion 32(3) is formed with yet a different pattern of surface enhancement features 40 in order to once again modify the overall surface area of the heat transfer surface provided in that portion of the flow passage. As shown, the third parallel flow passage portion 32(3) is formed with surface enhancement features 40 in the form of a low density pattern of ribs 40 arranged across the surface of the third generally parallel flow passage portion 32(3) to once again provide an overall medium density surface area that is higher than the medium density surface area provided by the second flow passage portion 32(2). Accordingly, the third flow passage portion 32(3) offers a higher density surface area as compared to the first flow passage portion 32(1) and that also has a slightly higher density surface area than the second flow passage portion 32(2). The fourth parallel flow passage portion 32(4) is formed with an even higher density pattern of surface enhancement features 42 as compared to the previous flow passage portions 32(1)-32(3) and is in the form of a high density pattern of slightly elongated dimples (or truncated ribs) so as to provide an overall high density surface area in the fourth flow passage portion 32(4) as compared to the previous flow passage portions 32(1)-32(3). Accordingly, the heat exchanger plates 16, 18 together provide an internal tubular flow passage 20 that in essence provides a different heat transfer surface in each, individual pass of the multi-pass flow passage 20 with a progressively higher density pattern of surface enhancement features in the form of dimples and/or ribs formed in the surface of at least the second plate 18 so as to progressively increase the flow resistance and heat transfer performance through the flow passage 20. Accordingly, graded or varied surface enhancement features serve to change/alter both the overall surface area of the flow passage 20 as well as the velocity of the fluid passing through the heat exchanger 14 thereby offering different heat transfer properties/results through each pass of the multi-pass flow passage 20 of the heat exchanger 14.

While the above described embodiment relates to providing a flow passage 20 with surface enhancement features 36, 38, 40, 42 in the form of ribs and/or dimples that are stamped or otherwise formed directly in the surface of at least the second plate 18, it will be understood that similar results may be achieved by inserting different heat transfer enhancement surfaces such as turbulizers or fins within each of the generally parallel flow passage portions 32(1)-32(4) of the flow passage 20, as illustrated schematically in FIG. 3A. For instance, various grades of off-set strip fins 43 may be used to progressively change the flow characteristics through each pass of the multi-pass flow passage 20 to achieve similar results. In one example embodiment, the first generally parallel flow passage may be left as an open channel with no surface enhancement features or turbulizers positioned therein, while the second, third and fourth generally parallel flow passage portions 32(2)-32(4) may each be provided with various grades of turbulizers or off-set strip fins 43(1)-43(3). More specifically, the second flow passage portion 32(2) may be fitted with, for instance, an off-set strip fin having a lance (or flow length) of about 20 mm and a width (or flow width) of about 10 mm (e.g. OSF 20/10*), while the third flow passage portion 32(3) may be fitted with an off-set strip fin having a lance (or flow length) of about 10 mm and a width (or flow width) of 5 mm (e.g. OSF 10/5*), and while the fourth flow passage portion 32(4) may be fitted with an off-set strip fin having a lance (or flow length) of about 5 mm with a width (or flow width) of about 2 mm (e.g. OSF 5/2*), respectively. Accordingly, each pass of the multi-pass flow passage 20 provides for different flow characteristics through the flow passage portions 32(n) resulting in different heat transfer properties which helps to provide a more uniform temperature distribution across the surface of the heat exchanger 14.

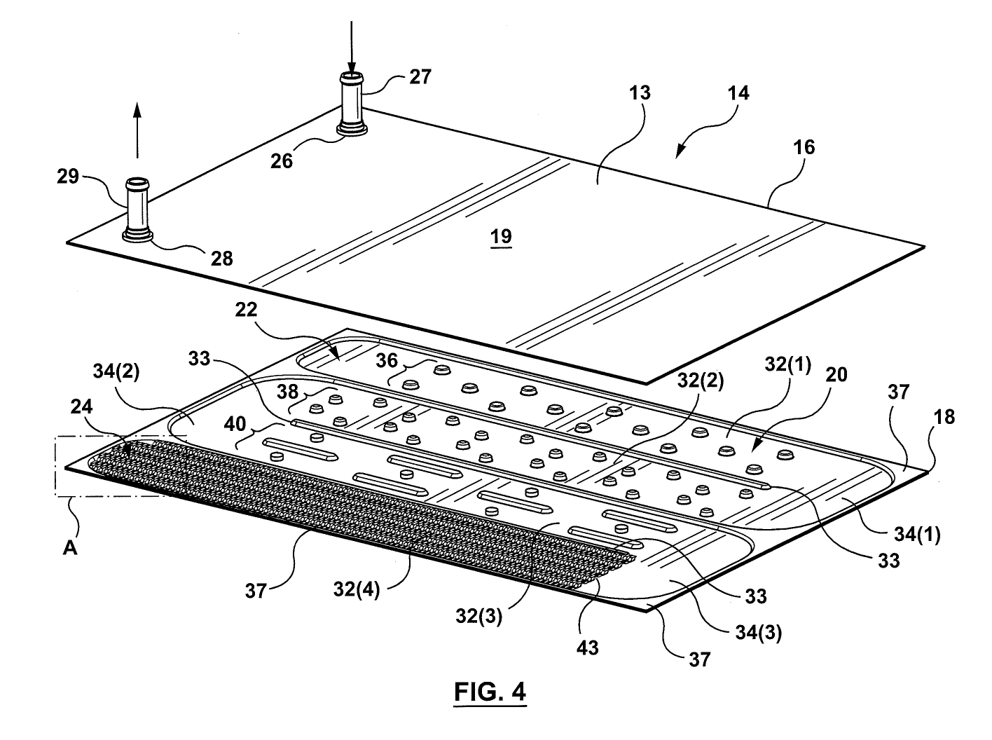

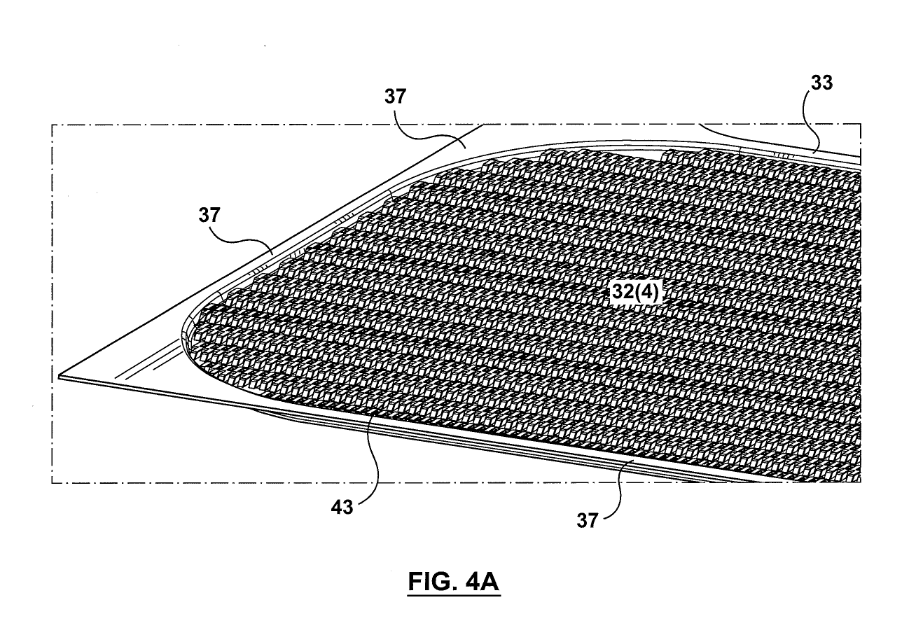

In another embodiment, the surface area of each of the generally parallel flow passage portions 32(n) may be varied using a combination of surface enhancement features formed in the surface of the flow passage 20 itself and separate turbulizers. More specifically, the embodiment shown in FIG. 3B illustrates an example embodiment wherein the first generally parallel flow passage portion 32(1) is formed with a low density pattern of surface enhancement features 36, such as dimples, while the second generally parallel flow passage portion 32(2) is formed with a medium density pattern of surface enhancement features 38 as compared to the first flow passage portion 32(1), such as a higher density pattern of dimples, similar to the embodiment shown in FIG. 3. The third generally parallel flow passage portion 32(3) is formed with a higher density pattern of surface enhancement features 40 as compared to the second flow passage portion 32(2), which in the subject embodiment, is in the form of a higher density combination pattern of elongated ribs and dimples. The fourth generally parallel flow passage 32(4), rather than being formed with a high density pattern of surface enhancement features, is instead provided with a turbulizer, such as an off-set strip fin, that provides a higher density surface enhancement feature as compared to the third flow passage portion 32(3). FIG. 4 illustrates a battery cell heat exchanger 14 incorporating the second plate 18 with a combination of surface enhancement features 36, 38, 40 as well as a separate turbulizer as shown in FIG. 3B, with FIG. 4A providing a detail view of the turbulizer arranged in the fourth generally parallel flow passage portion 32(4) providing the highest degree of surface enhancement in the flow passage portion 32(4) associated with the outlet 29 end of the heat exchanger 14.

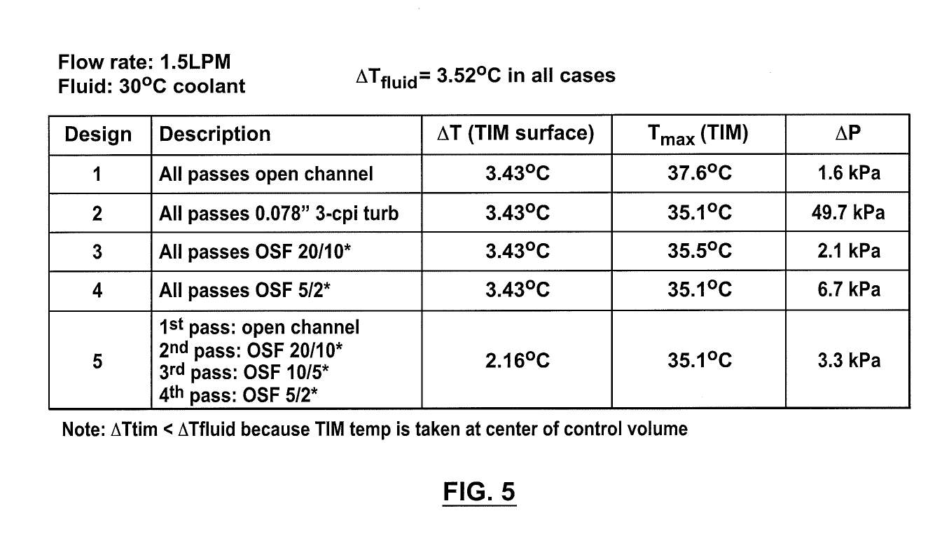

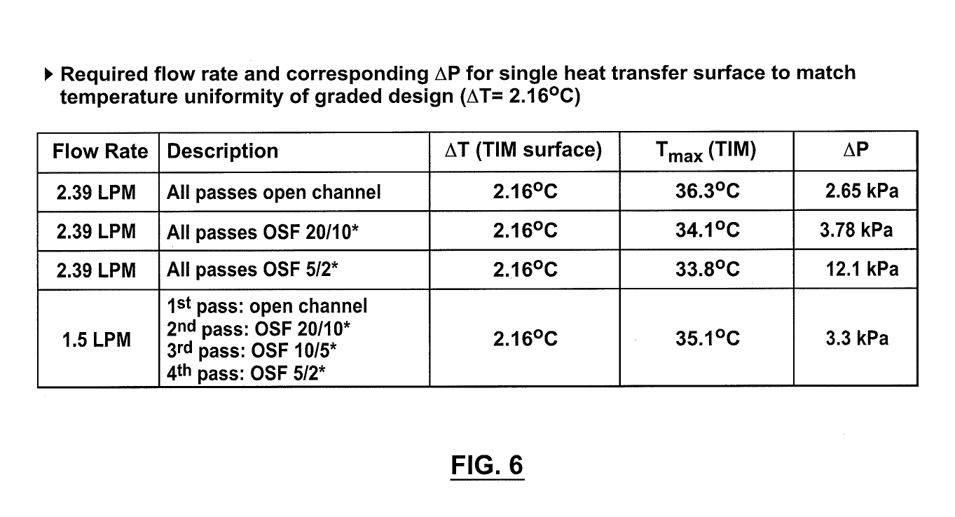

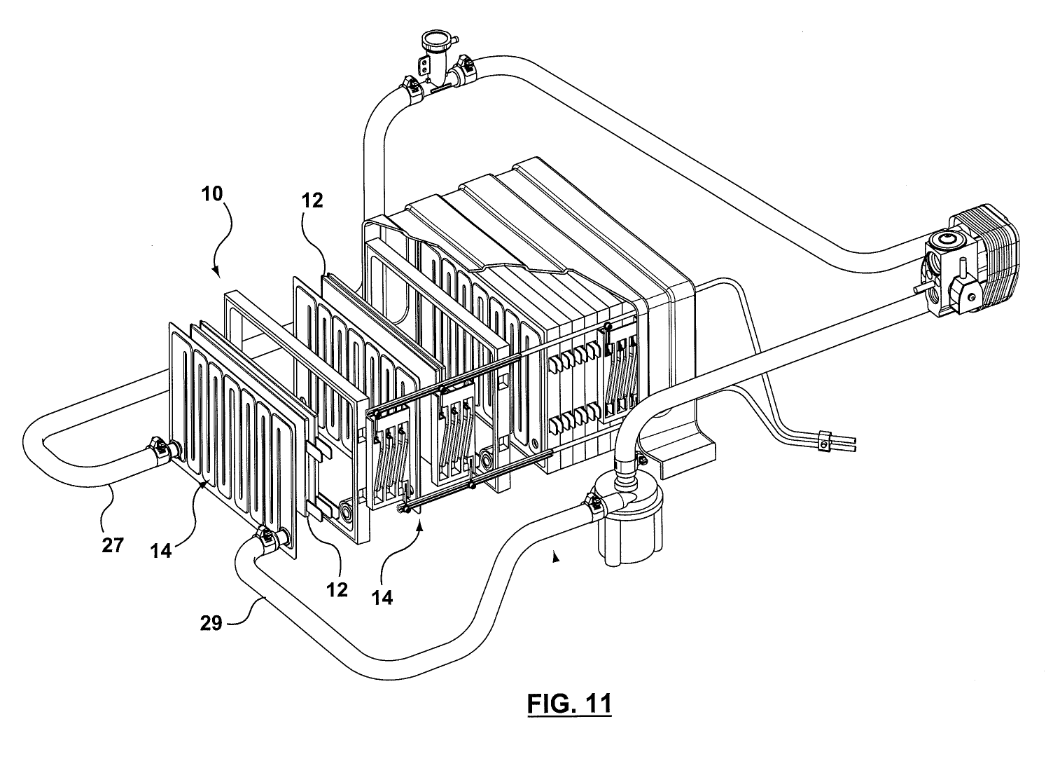

While the embodiments illustrated in FIGS. 2 and 4 show a heat exchanger 14 having a generally planar first plate 16 and a formed second plate 18 with the two plates 16, 18 being arranged in mating relationship to enclose the varied or graded flow passage 20 therebetween as is suitable for use as a cold plate heat exchanger, it will be understood that the first plate 16 could also be a formed plate that is generally identical in structure to the formed second plate 18 shown in the drawings but formed as the mirror image thereof and arranged upside down or inverted with respect to the second plate 18 so that when the plates 16, 18 are arranged in face-to-face mating relationship they enclose the serpentine flow passage 20 therebetween. In such an arrangement, the serpentine depression forming the generally parallel flow passage portions 32(n) and the U-shaped flow passage portions 34(n−1) would project out of the central generally planar portion of the first or upper plate 16 of the heat exchanger 14 and be in the form of an embossment, the spaced-apart walls of the serpentine embossment formed in the first plate 16 and the serpentine depression formed in the second plate 18 together forming flow passage 20. Accordingly, in such an embodiment, when the first and second plates are arranged in their mating relationship the various patterns of surface enhancement features 36, 38, 40, 42 in each of the flow passage portions 32(n) of one plate 16, 18 would abut with the corresponding surface enhancement feature 36, 38, 40, 42 of the other plate 16, 18. In embodiments where open channels are provided with separate individual turbulizers 43 being provided, the turbulizers would be formed so as to have a height that corresponds to the height of the generally parallel flow passage portions 32(n) formed by the mating serpentine embossment and serpentine depression of first and second plates 16, 18. A heat exchanger 14 formed by two formed plates 16, 18 as described above (as compared to a generally planar first or upper plate 16 and a formed second or lower plate 18) is generally more suitable for use as an ICE plate heat exchanger as shown for instance in FIG. 11 wherein a battery cell cooler or heat exchanger 14 is arranged or sandwiched between adjacent battery cells or battery cell cases 12 with each side of the heat exchanger 14 being in surface-to-surface contact with the adjacent battery cell or battery cell case 12. In such an arrangement, the inlet fixture 27 may be in the form of an inlet duct or feed pipe that is fluidly coupled to the inlet opening 26 of each battery cell heat exchanger 14 while the outlet fixture 29 may be in the form of an outlet duct or discharge pipe that is fluidly coupled to the outlet opening 28 of each battery cell heat exchanger 14, the inlet and outlet fixtures 27, 29 associated with each battery cell heat exchanger 14 being linked or fluidly coupled together within the battery unit 10 therefore providing a fluid system for supplying a cooling/warming fluid to the plurality of battery cell heat exchangers 14 within the battery unit 10 and for returning the cooling/warming fluid back to its fluid source. FIGS. 5 and 6 illustrate performance results for various heat exchanger plates with Design 5 relating to a heat exchanger 14 in accordance with the embodiment described above in connection with FIGS. 2-4 wherein various grades of off-set strip fins have been used in place of surface enhancement features formed directly in the surface of the heat exchanger plates to provide a graded heat transfer surface, with all heat exchangers being supplied with a heat exchange or cooling fluid at a temperature of 30° C. at a flow rate of 1.5 LPM and where the change in temperature of the heat exchange fluid entering and exiting the heat exchanger, i.e. ΔT_{fluid}=Tₒᵤₜ Tᵢₙ being held constant at 3.52° C. As shown in FIG. 5, the temperature gradient at the surface of the plates is reduced, i.e. ΔT=2.16° C., for the graded heat transfer surface where each pass of the multi-pass heat exchanger 14 is formed or provided with a different heat transfer surface, as compared to other standard heat exchanger configurations (designs 1-4) where each pass is formed/provided with the same heat transfer surface, while also maintaining a relatively low pressure drop. FIG. 6 illustrates that in order to achieve the reduced temperature gradient of 2.16° C. as demonstrated by the heat exchanger 14 incorporating heat exchanger plates 16, 18 with a graded heat transfer surface as shown for instance in FIGS. 2-4, the other known heat exchanger structures (i.e. designs 1-4) would require an increased flow rate of the heat exchange fluid entering the various heat exchangers which has been known to have an adverse effect on pressure drop and overall performance of the heat exchanger.

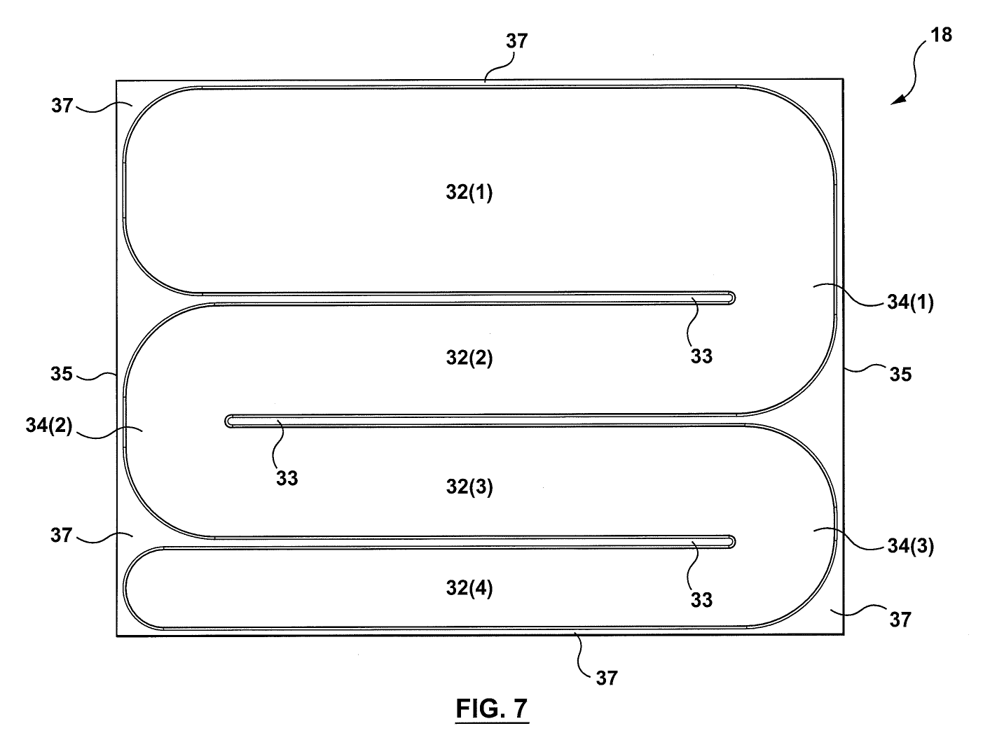

In addition to altering the flow resistance and heat transfer performance of each pass of the multi-pass flow passage 20 by providing each flow passage portion 32(1)-32(4) with varying grades of surface enhancement features (e.g. varying patterns of protrusions such as dimples and/or ribs) or heat transfer surfaces (e.g. off-set strip fins) ranging from low, to medium, to high density surface areas in a progressive fashion from one adjacent flow passage portion to the subsequent adjacent flow passage portion as described above in connection with FIGS. 2-4, the surface area may further be altered by also varying the channel width of the flow passage portions 32(1)-32(4). More specifically, referring now to FIG. 7 there is shown another example embodiment of a heat exchanger plate 18 for forming a battery cell heat exchanger 14 according to the present disclosure. In the subject embodiment, each of the generally parallel fluid passage portions 32(1)-32(4) is formed with a different channel width. More specifically, the first fluid passage portion 32(1) has a first channel width while each subsequent fluid passage portion 32(2)-32(4) has a progressively smaller channel width thereby varying the flow characteristics through the flow passage 20. For instance, in one example embodiment, the first fluid passage portion 32(1) has a channel width of about 119.7 mm, the second fluid passage portion 32(2) has a channel width of about 102.6 mm, the third fluid passage portion 32(3) has a width of about 68.4 mm and the fourth fluid passage portion has a channel width of about 51.3 mm, all of the fluid passage portions 32(1)-32(4) having a channel height of about 2 mm, for example. By providing a flow passage 20 with a variable channel width, the flow characteristics through each pass of the multi-pass flow passage 20 changes with the velocity of the fluid flowing through the passage 20 increasing as the channel width becomes progressively smaller. The increase in the velocity of the fluid flowing through flow passage 20 increases the heat transfer coefficient, h, of the surface forming the flow passage through each pass of the multi-pass flow passage 20 which helps to achieve temperature uniformity across the heat exchanger plates 16, 18. As in the previously described embodiments, the heat exchanger plate illustrated in FIG. 7 could be arranged as the bottom or second plate 18 of the overall battery cell heat exchanger 14 with a first generally planar plate 16 arranged in mating relationship with the formed second plate 18 to form the enclosed fluid flow passage 20. Alternatively, the heat exchanger 14 could be formed of two complimentary heat exchanger plates having the form illustrated in FIG. 7 which arrangement may be more suitable for use as an ICE plate heat exchanger.

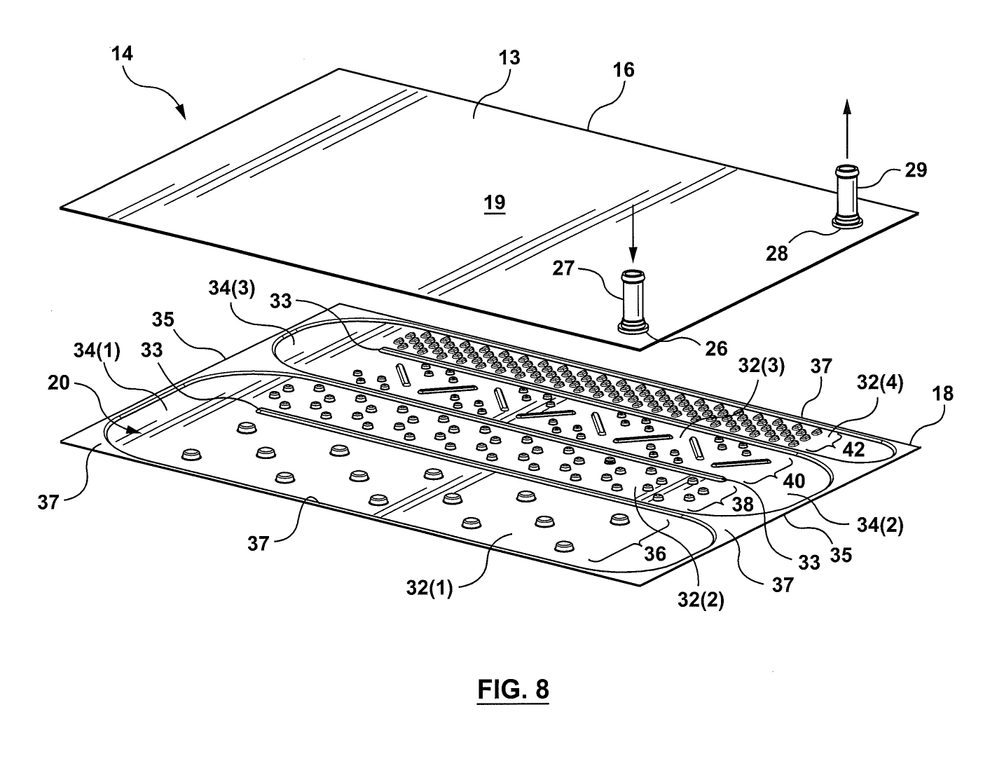

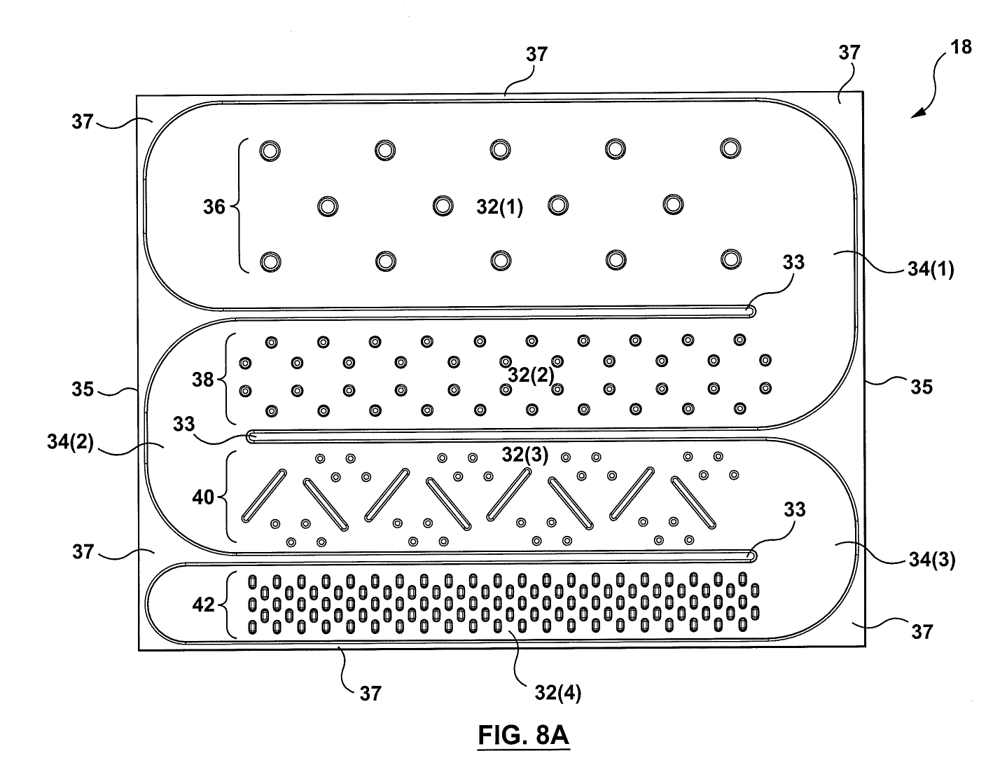

While the battery cell heat exchanger 14 may be provided with a flow passage 20 having a graded heat transfer surface as shown in FIGS. 2-4, or may be provided with a flow passage 20 having a variable channel width as shown in FIG. 7 in an effort to improve the temperature uniformity of the surface of the heat exchanger plates 16, 18, it has been found that the overall temperature uniformity of the battery cell heat exchanger 14 can be further improved by combining the features of both the graded heat transfer surface as described above in connection with FIGS. 2-4 as well as the variable channel width as described above in connection with FIG. 7 as is shown, for example in FIGS. 8 and 8A. Therefore, in accordance with another example embodiment of the present disclosure, heat exchanger 14 is formed with mating plates 16, 18 wherein the first or upper plate 16 is in the form of a generally planar plate having an outer surface 19 that is generally free of surface interruptions providing a large surface area for contacting with the adjacent or corresponding battery cells or battery cell cases 12. The second or bottom plate 18 of the heat exchanger 14 has central, generally planar area in which the generally serpentine flow passage 20 is formed. In the subject embodiment, the generally parallel flow passage portions 32(1)-32(4) (or in general 32(n)) and the U-shaped flow passage portions 34(1)-34(3) (or in general 34(n−1)) are formed as a serpentine depression that extends outwardly away from the central generally planar area of the second plate 18, the flow passage 20 being formed so as to incorporate both a graded heat transfer surface as well as a variable channel width. More specifically, as shown in FIG. 8A, each of the generally parallel flow passage portions 32(1)-32(4) is formed with a progressively smaller channel width as described in connection with FIG. 7, and is also provided with various grades of surface enhancement features or various grades of heat transfer surfaces (e.g. turbulizers in the form of off-set strip fins for example) as described above in connection with FIGS. 2-4. Accordingly, in the subject embodiment, the first flow passage portion 32(1) with the largest channel width is provided with low density pattern of dimples while in other embodiments it may be provided with a low density heat transfer surface (or turbulizer), and in some instances may instead be left as an open channel with no surface enhancement features or heat transfer surfaces. The second flow passage portion 32(2) is formed with a smaller channel width than the first flow passage portion 32(1) and is provided with medium density surface enhancement feature such as high density pattern or dimples (or an equivalent heat transfer surface or turbulizer). The third flow passage portion 32(3) is formed so as to have an even smaller channel width than both the first and second flow passage portions 32(1), 32(2) and is provided with an increased medium density pattern of surface enhancement features such as a low density pattern of ribs or a combined pattern of dimples and ribs (or an equivalent heat transfer surface or turbulizer) that offers an increased surface area density as compared to the overall medium surface area density provided by the high density pattern of dimples of the second flow passage portion 32(2), while the fourth flow passage portion 32(4) is provided with a high density pattern of surface enhancement features (or an equivalent heat transfer surface or turbulizer) such as an even higher density pattern of surface enhancement features (such as dimples, elongated dimples or truncated ribs or a combination of dimples and ribs) and an even smaller channel width as compared to the previous channel portions. While reference has been made to low density dimples, high density dimples, low density ribs and a high density pattern of dimples and ribs, it will be understood that various patterns of surface enhancement features may be provided, the key being that the dynamics of the fluid flowing through each pass of the multi-pass flow passage 20 be changed so as to progressively increase flow resistance and/or heat transfer performance through each flow passage portion 32(1)-32(4) along the overall length of the flow passage 20 from the inlet end 22 to the outlet end 24 of the heat exchanger 14. As discussed above, it will also be understood that rather than forming the heat exchanger plates 16, 18 with various patterns of surface enhancement features formed directly in each of the fluid passage portions 32(1)-32(4), various types of heat transfer surfaces, such as individual turbulizers, can instead be positioned within each of the fluid passage portions 32(1)-32(4) to achieve similar effects. While specific reference has been made to various grades of off-set strip fins it will be understood that any suitable heat transfer surface or turbulizer as is known in the art may be used and that the reference to various grades of offset strip fins is meant to be exemplary and is not intended to be limiting.

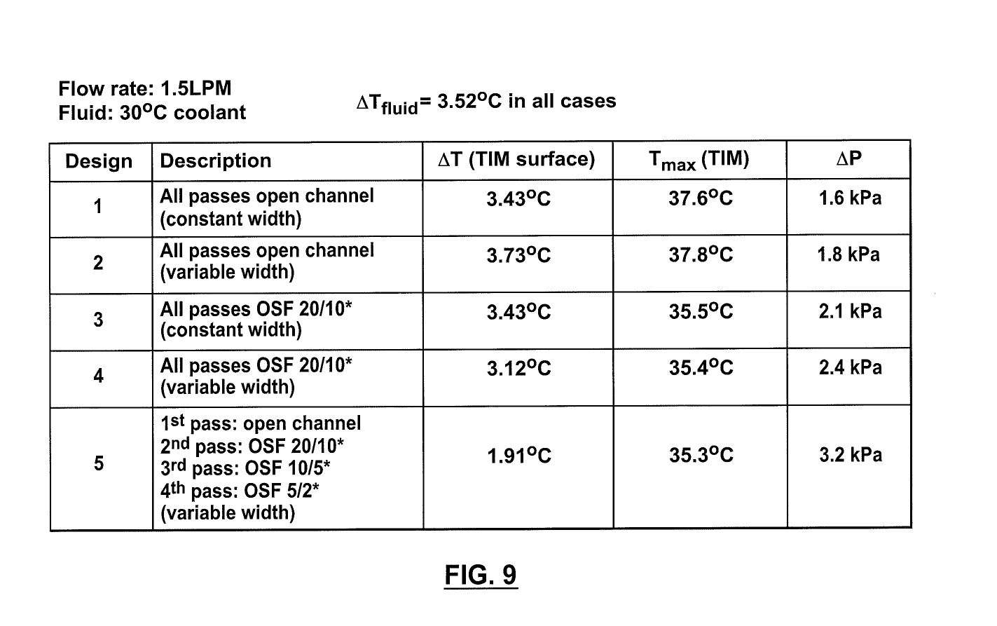

FIG. 9 illustrates performance results for various heat exchanger designs. More specifically, the first design (i.e. Design 1) relates to a heat exchanger having all passes of the multi-pass flow passage 20 having a constant width with no surface enhancement features (or turbulizers). The second design (i.e. Design 2) represents a heat exchanger 14 as shown in FIG. 7 where the fluid flow passage portions have variable channel width with no surface enhancement features (or turbulizers). The third design (i.e. Design 3) relates to a heat exchanger with a multi-pass flow passage having a constant width that is provided with the same heat transfer surface or turbulizer in each flow passage portion as illustrated schematically in FIG. 3A, while the fourth design (i.e. Design 4) is a heat exchanger with a multi-pass flow passage having a variable channel width where each pass is provided with the same surface enhancement features or heat transfer surface in each flow passage portion 32(1)-32(4) (e.g. similar to FIG. 7 with appropriate surface enhancement features or turbulizers). The fifth design (i.e. Design 5) relates to a heat exchanger as shown in FIGS. 8 and 8A wherein the heat exchanger comprises a multi-pass flow passage 20 having a variable channel width where each flow passage portion 32(1)-32(4) is provided with surface enhancement features or a heat transfer surface or turbulizer of progressively increasing density. As illustrated in the results table shown in FIG. 9, the fourth design (i.e. Design 4) and the fifth design (i.e. Design 5) both demonstrate an improved temperature gradient over the surface of the heat exchanger plates 16, 18 as compared to the other designs (i.e. Designs 1-3). With regards to Design 4 where the heat exchanger 14 was provided with an internal tubular flow passage 20 having a variable channel width that progressively decreases from one flow passage portion to the subsequent flow passage portion, each flow passage portion being provided with the same surface enhancement features or heat transfer surface (e.g. turbulizer), it was found that the overall temperature gradient across the surface of the plates was about 3.12° C. which was decreased as compared to Designs 1-3 and therefore offered improved temperature uniformity. As for Design 5, which relates to a heat exchanger 14 having both a variable channel width as well as a graded heat transfer surface along the length of the flow passage, the results were even more notable with the temperature gradient across the surface of the heat exchanger plates 16, 18 being even further reduced to about 1.91° C. which is a significant improvement of temperature uniformity across the surface of the heat exchanger plates 16, 18 as compared to the other designs (i.e. Designs 1-4). While the overall pressure drop across the heat exchanger 14 was slightly increased as compared to each of Designs 1-4, an overall pressure drop of 3.2 kPa is still within a reasonable range especially in light of the much improved temperature uniformity requirement.

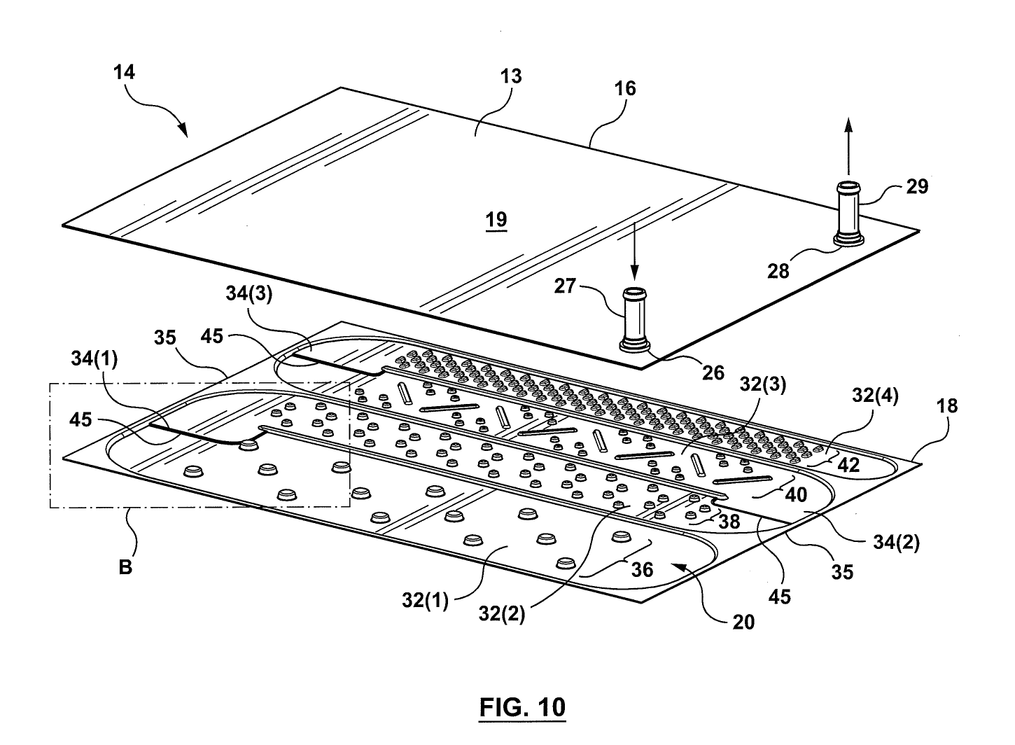

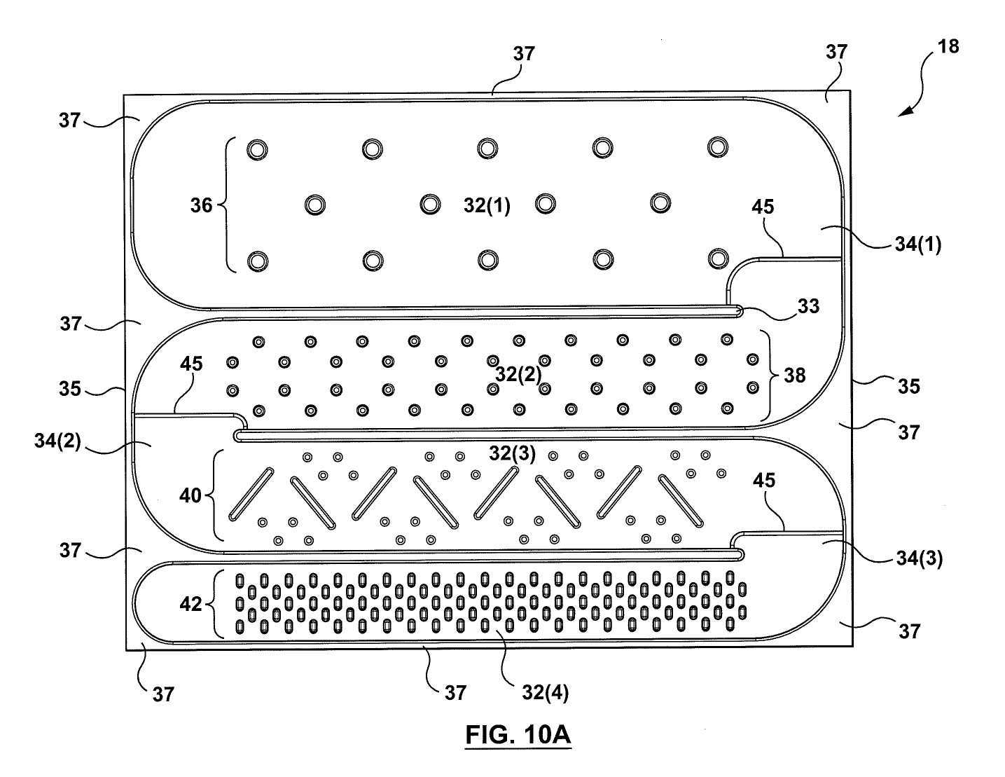

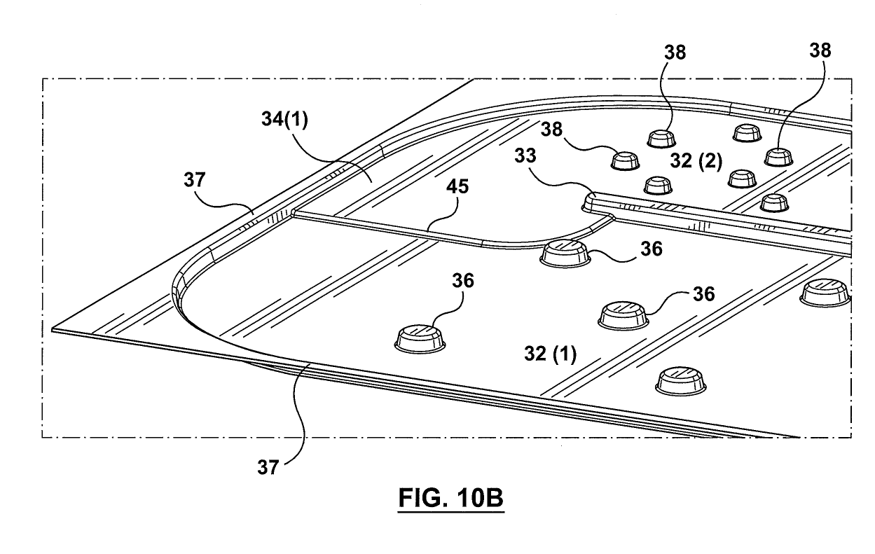

Referring now to FIG. 10 there is shown another exemplary embodiment of a battery cell heat exchanger 14 according to the present disclosure. In the subject embodiment, rather than providing a serpentine flow passage 20 having a variable width and/or variable graded heat transfer surface for each pass of the multi-pass flow passage 20, each generally parallel flow passage portion 32(1)-32(4) is formed with a different channel height Dh1-Dh4 as well as a different channel width, the channel height Dh1 of the first flow passage portion 32(1) being greater than the channel height Dh2 of the second flow passage portion 32(2), the channel height Dh3 of the third flow passage portion 32(3) being less than the second channel height Dh2, and the channel height Dh4 of the fourth flow passage portion 32(4) being less than the third channel height Dh3. More specifically, as shown in FIG. 10, the heat exchanger 14 is comprised of a pair of mating heat exchanger plates 16, 18 wherein the second heat exchanger plate 18 is formed with a serpentine depression forming flow passage 20 that is made up of a series of generally parallel flow passage portions 32(1)-32(4) that are serially interconnected by U-shaped flow passage portions 34(1)-34(3). Longitudinal ribs that extend from the respective end edges of the plate 18 for individual flow barriers 33 that separate and/or fluidly isolate one generally parallel flow passage portion 32(n) from the adjacent flow passage portion. In the subject embodiment, transition zones 45 are formed in each U-shaped flow passage portion 34(1)-34(3) in order to provide for the decrease in channel height between the adjacent generally flow passage portions 32(n). The transition zones 45 are generally in the form of a gradual step or ramp formed in the surface of the U-shaped flow passage portion 34(1)-34(3) that allows for the decrease in height between the adjacent generally parallel flow passage portions 32(n), the channel height of the respective flow passage portions 32(n) corresponding to the depth provided by the respective depressions forming the respective flow passage portion 32(n), e.g. the channel height of the respective flow passage portions 32 corresponding to the distance between the base or bottom surface of the respective flow passage portion 32 and the upper surface of the adjacent flow barrier 33 or the surrounding peripheral edge 37. A more detailed view of the transition zone 45 provided by one of the U-shaped flow passage portions 34(1) being illustrated in FIG. 10B.

By progressively decreasing the channel height of the individual flow passage portions 32(1)-32(4) along with the width, the flow resistance of each flow passage portion increases which in turn increases the velocity of the fluid flowing through the flow passage portions 32(1)-32(4) which in turn helps to reduce the temperature gradient across the surface of the heat exchanger plates 16, 18 in contact with the individual battery cells. In addition to progressively decreasing the channel height of each generally parallel flow passage portion 32(1)-32(4), each flow passage portions 32(1)-32(4) may also be provided with various patterns of surface enhancement features 36, 38, 40, 42 or heat transfer surfaces in the form of various grades of offset strip fins as described above. A battery cell heat exchanger 14 having a serpentine or multi-pass flow passage 20 having a graded or varied heat transfer surface as well as a progressively decreasing channel height is generally considered more suitable for use as a cold plate heat exchanger since one side of the heat exchanger does not provide a generally continuous surface for contacting an adjacent battery cell or battery cell case 12 as is required when used in an inter-cell arrangement (e.g. as shown in FIG. 11). A battery cell heat exchanger 14 having a multi-pass flow passage 20 having progressively decreasing channel height from the inlet end to the outlet end of the heat exchanger that is made up of a generally planar first or upper plate 16 and a formed second or lower plate 18 as shown in FIG. 10 is suitable for use as a cold plate heat exchanger wherein only one side of the heat exchanger is in surface-to-surface contact with the battery cells or battery cell containers 12.

By applying a graded heat transfer surface and/or a variable width and/or height to the flow passage 20 of a battery cell heat exchanger 14, an improved battery cell heat exchanger 14 is provided that can be more specifically tuned to meet the specific performance requirements of these types of battery units 10, in particular a more uniform temperature distribution across the surface of the heat exchanger 14.

While various embodiments of the battery cell heat exchanger 14 have been described, it will be understood that certain adaptations and modifications of the described embodiments can be made. Therefore, the above discussed embodiments are considered to be illustrative and not restrictive.

What is claimed is:

1. A battery cell heat exchanger comprising:
a pair of mating heat exchange plates, the pair of mating heat exchange plates together forming an internal multi-pass tubular flow passage therebetween;
the multi-pass tubular flow passage having an inlet end and an outlet end and a plurality of generally parallel flow passage portions interconnected by generally U-shaped flow passage portions, the generally parallel flow passage portions and generally U-shaped portions together interconnecting said inlet end and said outlet end;
a fluid inlet in fluid communication with said inlet end of said flow passage for delivering a fluid to said heat exchanger;
a fluid outlet in fluid communication with said outlet end of said flow passage for discharging said fluid from said heat exchanger; wherein each generally parallel flow passage portion defines a flow resistance and heat transfer performance characteristic, the flow resistance and heat transfer performance characteristic of each of said generally parallel flow passage portions increasing between the inlet end and the outlet end.

2. A battery cell heat exchanger as claimed in claim 1, wherein each generally parallel flow passage portion has a width, the width of each generally flow passage portion being the same and constant; and
wherein each generally parallel flow passage portion defines a progressively increasing surface area density with respect to a subsequent generally parallel flow passage portion;
wherein the progressively increasing surface area density is provided by one of the following alternatives: surface enhancement features in the form of various patterns of dimples, ribs and/or combinations thereof, or heat transfer surfaces having progressively increasing fin density.

3. A battery cell heat exchanger as claimed in claim 1, wherein each generally parallel flow passage portion has a width, the width of each of said generally parallel flow passage portions progressively decreasing from a first one of said generally parallel flow passage portions to a last one of said generally parallel flow passage portions.

4. A battery cell heat exchanger as claimed in claim 3, wherein each of said generally parallel flow passage portions having progressively decreasing widths are each formed with surface enhancement features arranged in patterns with progressively increasing surface area density from said first one of said generally parallel flow passage portions to said last one of said generally parallel flow passage portions; wherein said surface enhancement features are stamped into the surface of said heat exchanger plates.

5. A battery cell heat exchanger as claimed in claim 3, wherein said first one of said generally parallel flow passage portions is in the form of an open channel free of surface enhancement features; and wherein a heat transfer surface is arranged in each subsequent generally parallel flow passage portion, each heat transfer surface having a progressively increasing fin density.

6. A battery cell heat exchanger as claimed in claim 5, wherein each heat transfer surface is in the form of an offset strip fin of progressively increasing fin density.

7. A battery cell heat exchanger as claimed in claim 1, wherein the multi-pass tubular flow passage comprises a first generally parallel flow passage portion defining a first surface area density; a second generally parallel flow passage portion defining a second surface area density; a third generally parallel flow passage portion defining a third surface area density; and a fourth generally parallel flow passage defining a fourth surface area density;
wherein said first surface area density is defined by a low density pattern of first protrusions formed in the surface portion of the heat exchanger plates forming said first generally parallel flow passage portion to provide a low overall surface area density; said second surface area density is defined by a high density pattern of said first protrusions formed in the surface portion of the heat exchanger plates forming said second generally parallel flow passage portion to provide a first medium overall surface area density; said third surface area density is defined by a low density pattern of second protrusions formed in the surface portion of the heat exchanger plates forming said third generally parallel flow passage portion to provide a second medium overall surface area density that is greater than said first medium surface area density; and said fourth surface area density is defined by a high density pattern of said first and second protrusions formed in the surface portion of said heat exchanger plates forming said fourth generally parallel flow passage portion to provide an overall high surface area density.

8. A battery cell heat exchanger as claimed in claim 7, wherein said first protrusions are dimples and said second protrusions are ribs.

9. A battery cell heat exchanger as claimed in claim 7, wherein:
said first surface area density is defined by an open channel free of surface enhancement features or a heat transfer surface; and
said second, third and fourth surface area densities are defined by heat transfer surfaces in the form of offset strip fins of progressively increasing fin density.

10. A battery cell heat exchanger as claimed in claim 1, wherein said multi-pass tubular flow passage comprises a minimum of three generally parallel flow passage portions and a maximum of ten generally parallel flow passage portions.

11. A battery cell heat exchanger as claimed in claim 3, wherein each generally parallel flow passage portion has a height, the height of each of said generally parallel flow passage portions progressively decreasing from a first one of said generally parallel flow passage portions to a last one of said generally parallel flow passage portions.

12. A battery cell heat exchanger as claimed in claim 11, wherein each of said generally parallel flow passage portions having progressively decreasing heights are each formed with surface enhancement features arranged in patterns with progressively increasing surface area density from said first one of said generally parallel flow passage portions to said last one of said generally parallel flow passage portions; wherein the progressively increasing surface area density is provided by one of the following alternatives: surface enhancement features in the form of various patterns of dimples, ribs and/or combinations thereof, or heat transfer surfaces having progressively increasing fin density.

13. A battery unit comprising:
a plurality of battery cell containers each housing one or more individual battery cells wherein the battery cell containers are arranged in adjacent, face-to-face contact with each other;
a battery cell heat exchanger arranged underneath said plurality of battery cell containers such that an end face of each battery cell container is in surface-to-surface contact with said heat exchanger;
wherein each battery cell heat exchanger comprises:
a pair of mating heat exchange plates, the pair of mating heat exchange plates together forming a multi-pass tubular flow passage therebetween;
the multi-pass tubular flow passage having an inlet end and an outlet end and a plurality of generally parallel flow passage portions interconnected by generally U-shaped flow passage portions, the generally parallel flow passage portions and generally U-shaped portions together interconnecting said inlet end and said outlet end;
a fluid inlet in fluid communication with said inlet end of said flow passage for delivering a fluid to said heat exchanger;
a fluid outlet in fluid communication with said outlet end of said flow passage for discharging said fluid from said heat exchanger; wherein each generally parallel flow passage portion defines a flow resistance and heat transfer performance characteristic, the flow resistance and heat transfer performance characteristic of each generally parallel flow passage portion increasing between the inlet end and the outlet end.

14. A battery unit as claimed in claim 13, wherein each generally parallel flow passage portion has a width, the width of each generally flow passage portion being the same and constant; and
wherein each generally parallel flow passage portion defines a progressively increasing surface area density with respect to a subsequent generally parallel flow passage portion;
wherein the progressively increasing surface area density is provided by one of the following alternatives: surface enhancement features in the form of various patterns of dimples, ribs and/or combinations thereof, or heat transfer surfaces having progressively increasing fin density.

15. A battery unit as claimed in claim 13, wherein each generally parallel flow passage portion has a width, the width of each of said generally parallel flow passage portions progressively decreasing from a first one of said generally parallel flow passage portions having the largest width to a last one of said generally parallel flow passage portions having the smallest width.

16. A battery unit as claimed in claim 15, wherein each of said generally parallel flow passage portions having progressively decreasing widths are each formed with surface enhancement features arranged in patterns with progressively increasing surface area density from said first one of said generally parallel flow passage portions to said last one of said generally parallel flow passage portions;
wherein the multi-pass tubular flow passage comprises a first generally parallel flow passage portion defining a first surface area density; a second generally parallel flow passage portion defining a second surface area density; a third generally parallel flow passage portion defining a third surface area density; and a fourth generally parallel flow passage defining a fourth surface area density;
wherein said first surface area density is defined by a low density pattern of first protrusions formed in the surface portion of the heat exchanger plates forming said first generally parallel flow passage portion to provide a low overall surface area density; said second surface area density is defined by a high density pattern of said first protrusions formed in the surface portion of the heat exchanger plates forming said second generally parallel flow passage portion to provide a first medium overall surface area density; said third surface area density is defined by a low density pattern of second protrusions formed in the surface portion of the heat exchanger plates forming said third generally parallel flow passage portion to provide a second medium overall surface area density that is greater than said first medium surface area density; and said fourth surface area density is defined by a high density pattern of said first and second protrusions formed in the surface portion of said heat exchanger plates forming said fourth generally parallel flow passage portion to provide an overall high surface area density; and
wherein said first protrusions are dimples and said second protrusions are ribs.

17. A battery unit as claimed in claim 15, wherein said first one of said generally parallel flow passage portions is in the form of an open channel free of surface enhancement features; and wherein a heat transfer surface is arranged in each subsequent generally parallel flow passage portion, each heat transfer surface in the form of an offset strip fin having a progressively increasing fin density.

18. A battery unit as claimed in claim 15, wherein each generally parallel flow passage portion having decreasing width has a height, the height of each of said generally parallel flow passage portions progressively decreasing from a first one of said generally parallel flow passage portions to a last one of said generally parallel flow passage portions.

19. A battery cell heat exchanger as claimed in claim 1, comprising:
a first generally planar plate having an outer surface defining a primary heat transfer surface;
a second plate having a central generally planar area, a serpentine depression formed in said central generally planar area forming said multi-pass flow passage, wherein said serpentine depression is surrounded by a peripheral flange area for contacting and sealing against a corresponding surface of said first generally planar plate; and wherein flow barriers in the form of elongated ribs that project out of the central generally planar area of the second plate separate adjacent ones of said plurality of generally parallel flow passage portions, said U-shaped flow passage portions interconnecting said adjacent generally parallel flow passage portions about a respective end of one of said flow barriers;
wherein said battery cell heat exchanger is a cold plate heat exchanger.

20. A battery cell heat exchanger as claimed in claim 19, wherein said U-shaped flow passage portions further comprise a transition zone wherein the height of one generally parallel flow passage portion changes from a first depth to a second height corresponding to the depth of the adjacent generally parallel flow passage portion, the height of the generally parallel flow passage portions progressively decreasing from the inlet end to the outlet end of the heat exchanger.
